(19) United States
(12) Patent Application Publication
(10) Pub. No.: US 2024/0018624 A1
(43) Pub. Date: Jan. 18, 2024

(54) METHOD FOR SELECTIVE EXTRACTION OF GOLD BY NIACIN

(71) Applicant: INDIAN INSTITUTE OF TECHNOLOGY MADRAS (IIT MADRAS), Chennai, Tamil Nadu (IN)

(72) Inventors: Pradeep THALAPPIL, Chennai (IN); Nag ABHIJIT, Chennai (IN)

(73) Assignee: INDIAN INSTITUTE OF TECHNOLOGY MADRAS (IIT MADRAS), Chennai, Tamil Nadu (IN)

(21) Appl. No.: 18/034,958

(22) PCT Filed: Oct. 27, 2021
(86) PCT No.: PCT/IN2021/051021

§ 371 Date: May 2, 2023

(30) Foreign Application Priority Data
Nov. 3, 2020 (IN) 202041047984

(51) Int. Cl. C22B 11/00; C22B 3/10; C22B 3/06; C22B 3/22; C22B 7/00; C22B 11/02; C22B 3/44; C22B 5/08

(52) U.S. Cl. CPC C22B 11/042; C22B 3/10; C22B 3/065; C22B 3/22; C22B 7/007; C22B 11/021; C22B 3/44; C22B 5/08; C22B 7/002

(57) ABSTRACT

The present invention relates to a method for selectively precipitating and extracting gold in aqueous solution by niacin. Aqueous Au³⁺ is precipitated selectively as it's complex from gold containing acidic mixtures by biomolecule niacin, with the formula [AuCl₄]⁻[2Niacin+H]⁺. After precipitation, the complex is separated from impurities by filtration. Recovered complex is reduced by using a reductant like sodium metabisulfite (Na₂S₂O₅) to recover gold metal. The method is highly cost-effective, sustainable and recovers about 96.5% of gold in 2 minutes from an electronic waste composed of Au. Cu and Ni. The method is also employed to extract gold from nanomaterials waste generated in laboratories.

### FIELD OF THE INVENTION

The present invention generally relates to a method of extracting metals from mines as well as from chemical and electronic wastes in a sustainable fashion. More particularly, the invention relates to selective precipitation and extraction of gold by niacin.

### BACKGROUND OF THE INVENTION

Noble metals are distinguished from common metals in view of their exceptional physical and chemical properties [Jin R et al., Chem. Rev. 2016, 116 (18), 10346-10413; Chakraborty I. et al, Chem. Rev. 2017, 117(12), 8208-8271. Kang X et al., Chem. Soc. Rev. 2019, 48 (8), 2422-2457; Kazan, R. et al., Nanoscale 2019, 11 (6), 2938-2945; Kerrich R, Science 1999, 284 (5423), 2101; Mathew A, et al., Part. Part. Syst. Char. 2014, 31 (10), 1017-1053; Parker, J. F. et al., Acc. Chem. Res. 2010, 43 (9), 1289-1296; Song X.-R, et al., Analyst 2016, 141 (11), 3126-3140; Yamazoe S. et al., Acc. Chem. Res. 2014, 47 (3), 816-824; Yuan, X. et al., Chem. Asian J. 2013, 8 (5), 858-871]. Among them, gold is more popular since ancient times. The most universally used method for recovery of gold includes treatment of the ore with highly toxic sodium cyanide which results in the formation of the soluble coordination complex, Au(CN)₂⁻ [Cyano Compounds, Inorganic, Alkali Metal Cyanides, In Ullmann's Encyclopedia of Industrial Chemistry; Rubo, A et al., Ullmann's Encyclopedia of Industrial Chemistry, 2016]. Gold is also extracted with highly toxic mercury [de Lacerda, L. D et al., Springer Berlin Heidelberg, 2012]. This is currently the largest source of mercury pollution worldwide [Esdaile, L. J et al., Chemistry 2018, 24 (27), 6905-6916; Porcella, D. B. et al., Water, Air, and Soil Pollution 1997, 97 (3), 205-207].

As gold reserves are reducing day by day, it is necessary to recover gold from waste including nano and electronic wastes to meet the growing demand. Gold is one of the precious metals used in electronic devices due to its corrosion resistance and high electrical conductivity. About 263.3 MT of gold is utilized every year in electronic wastes [Rao, M. D et al., RSC Adv. 2020, 10 (8), 4300-4309]. A recent report suggested that recovery of metals from electronic waste is more cost effective than mining of ores [Zeng, X et al., Environ. Sci. Technol. 2018, 52 (8), 4835-4841].

Gold-based nanotechnology industries such as high-efficiency compact storage devices, medical diagnostics, photovoltaics, imaging, etc., are expected to expand significantly [Roco, M. C et al., J. Nanoparticle Res. 2011, 13 (3), 897-919; Wiek, A. et al., Futures 2009, 41 (5), 284-300]. The worldwide market value of gold nanoparticles (AuNPs) was projected to be 1.34 billion US dollars in 2014. The market for gold-based nanotechnologies is estimated to rise drastically by 2022. As a result, about 20,000 kg of gold will enter into the nanotechnology industry by that time [Market, G. N, Industry Report, 2022, GMI358, 2016].

Many methods have been reported for the recovery of gold. Stoddart et al. [Liu, Z et al., Nat. Commun. 2013, 4, 1855] utilized different cyclodextrins, where α-cyclodextrin showed efficient binding to AuBr₄⁻ to form a co-precipitate. Liu et al. have synthesized different types of macrocyclic tetralactam receptors which formed host-guest complexes with square planar complexes of noble metal halides like AuCl₄⁻, AuBr₄⁻, and PdCl₄⁻, etc [Liu, W et al., J. Am. Chem. Soc. 2018, 140 (22), 6810-6813]. Guo et al. selectively recovered gold using carbon nitride based on a photoreduction method [Guo, Y. et al., J. Mater. Chem. A 2014, 2 (46), 19594-19597]. Pati et al. recovered gold from nanowastes using Stoddart and co-worker's gold recovery method [Pati, P. et al., Environ. Sci.: Nano 2016, 3 (5), 1133-1143]. Recently, our group has developed a green method where noble metals like silver and copper were brought into solution from their metallic state using different types of carbohydrates [Baksi, A. et al., Angew. Chem. Int. Ed. 2016, 55 (27), 7777-7781; Nag, A et al., Eur. J. Inorg. Chem. 2017, 2017 (24), 3072-3079]. Different types of covalent organic frameworks (COFs) and metal-organic frameworks (MOFs) were also used to capture gold ions selectively from aqueous solutions [Zhou, Z. et al., Chem. Commun. 2018, 54 (71), 9977-9980; Mon, M. et al., J. Am. Chem. Soc. 2016, 138 (25), 7864-7867; Sun, D. T et al., J. Am. Chem. Soc. 2018, 140 (48), 16697-16703]. Recently, cucurbit[6]uril was utilised to extract gold selectively via coprecipitation [Wu, H, et al., ACS Appl. Mater. Interfaces 2020, 12 (34), 38768-38777]. Love et al., used a simple primary amide to extract gold selectively from electronic wastes [Angew. Chem. Int. Ed. 2016, 55 (40), 12436-12439].

The present invention overcome the deficiencies of the art by providing an environment-friendly, inexpensive, and efficient method for the recovery of gold from mines as well as from chemical and electronic wastes.

### OBJECTS OF THE INVENTION

An object of the present invention is to provide a method for selective recovery of gold from various waste samples including nano and electronic wastes.

Another object of the present invention is to provide a method for selective extraction of gold by precipitation process.

Yet another object of the present invention is to provide a method for selective extraction of gold by precipitation process, wherein such precipitation occurs even at low concentrations.

Another object of the present invention is to provide a method for rapid co-precipitation of [AuCl₄]⁻[2Niacin+H]⁺, abbreviated as I, in water from gold containing acidic mixtures by niacin.

Yet another object of the present invention is to provide a method for selective extraction of gold by precipitation process using niacin, wherein the [AuCl₄]⁻[2Niacin+H]⁺ is reduced by a reductant to recover gold metal.

### SUMMARY OF THE INVENTION

The present invention relates to a method for selective extraction of gold from mines as well as from chemical and electronic wastes. The said method involves rapid co-precipitation of [AuCl₄]⁻[2Niacin+H]⁺, abbreviated as I, in water from gold containing acidic mixtures by niacin.

In one embodiment, the present invention discloses a method for selective extraction of gold by precipitation process, wherein such precipitation occurs even at low concentrations using niacin, where niacin has the ability to recover gold down to 300 ppb.

In other embodiment, the present invention illustrates a rapid selective co-precipitation of [AuCl₄]⁻[2Niacin+H]⁺, abbreviated as I, in water from gold containing acidic mixtures by niacin. Electrostatic and supramolecular interactions such as hydrogen bonding and van der Waals (vdWs) interactions are responsible for such complexation, as revealed from single crystal studies. This phenomenon is highly selective for AuCl₄⁻ and excludes other commonly coexisting ions such as Cu²⁺, Zn²⁺ and Ni²⁺ present in such solutions, along with alkali (Na⁺/K⁺) and alkaline earth (Mg²⁺/Ca²⁺) metal ions. XPS and Raman studies also supported the formation of I.

In another embodiment, the present invention relates to a method for selective extraction of gold by precipitation process using niacin, wherein the [AuCl₄]⁻[2Niacin+H]+ in water from gold containing acidic mixtures is separated from impurities by filtration and then is reduced by a reductant to recover gold metal.

Other aspects of the invention will be set forth in the description which follows, and in part will be apparent from the description, or may be learnt by the practice of the invention

### BRIEF DESCRIPTION OF THE DRAWINGS

FIG. 1 Gold recovery flow chart using niacin

FIG. 2 Formation and co-precipitation of I after mixing a saturated solution (2 mL) of niacin to HAuCl₄ (27 mM, 1 mL). The light yellow color of the liquid meniscus on the right is due to the reflection from the precipitate.

FIG. 3 Co-precipitation of I after addition of niacin to a 300 ppb HAuCl₄ solution, maintained at pH 3. Color of HAuCl₄ at 300 ppb is faint. Precipitation is evident on the walls of the bottle.

FIG. 4 A) i) Crystal structure of I and ii) Chemdraw representation of I. Color codes for the atoms are shown nearby. Note that color of H atom is white. B) Expanded view (5×5×5) of the unit cell of I. C) Van der Waals interactions between halide ions of adjacent [AuCl₄]⁻ units. D) H-bonding interaction between O atom of the carboxylic group and H attached to N.

FIG. 5 Packing of the crystal. Views from, A) Z, B) X and C) Y axes.

FIG. 6 A) Packing view of the crystal from Y axis showing a layer kind of structure. B) Different non-covalent interactions such as H—Cl, Cl—Cl, Cl—C, and H—O present in the unit cell, with specific distances.

FIG. 7 Packing of AuCl₄⁻ in the crystal. Views from, A) Z, B) X and C) Y axes.

FIG. 8 Packing of [2Niacin+H]⁺ in the crystal. Views from, A) Z, B) X and C) Yaxes.

FIG. 9 A) Crystal structure of Cu(H₂O)₄(Niacin-H)₂. Color codes for the atoms are also shown. B) Unit cell of Cu(H₂O)₄(Niacin-H)₂.

FIG. 10 X-ray photoelectron spectroscopy (XPS) data of oxygen A), nitrogen B), and carbon C), respectively. Shift in the binding energy confirmed possible interactions in I. Data for pure niacin are also presented. Expanded Raman spectra of I are shown in FIG. 3D and F. D) C═N and C═O stretching in I and niacin. About 12 and 8 cm⁻ shifts were observed for I compared to only niacin for C═N and C═O, respectively. F) Au—Cl stretching in I and HAuCl₄.

FIG. 11 Separation of gold from an equimolar mixture of HAuCl₄, CuCl₂ and ZnCl₂ (i), using saturated solution of niacin. The precipitation of gold niacin complex is shown in (ii) and the copper zinc solution after centrifugation is shown in (iii).

FIG. 12 A)-B) Scanning electron microscopy (SEM) images of the precipitate. C) EDS spectrum of the precipitate. D) Elemental analyses data copper, gold and zinc. E) Elemental maps corresponding to zinc, copper, and gold are shown, along with a SEM image. Scale bar is the same for all the images.

FIG. 13 Recovery of gold from a central processing unit (CPU). A) The CPU was treated with HCl and HNO₃ (3:1) to dissolve the metals. The resulting solution (blue) was treated with saturated solution of niacin. B) Percentage removal of various metals evaluated by ICP MS.

FIG. 14 Schematic of the gold recovery process from gold nanowaste (i). Precipitation of bulk gold (iii) by reduction of gold niacin complex (ii) with Na₂S₂O₅ is shown.

FIG. 15 Co-precipitation of I after addition of saturated niacin solution in presence of 160,000 ppm NaCl and 50,000 ppm MgCl₂. Final concentration of the gold solution was 1 ppm.

FIG. 16 Co-precipitation of copper-niacin complex (ii) after addition of saturated niacin solution to an equimolar mixture (10 mM each) of HAuCl₄ and CuCl₂ in ethanol (i). By centrifugation, gold and copper are separated and HAuCl₄ is retained in solution (iii).

Referring to the drawings, the embodiments of the present invention are further described. The figures are not necessarily drawn to scale, and in some instances the drawings have been exaggerated or simplified for illustrative purposes only. One of ordinary skill in the art may appreciate the many possible applications and variations of the present invention based on the following examples of possible embodiments of the present invention.

### DETAILED DESCRIPTION OF THE INVENTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the scope of the present invention. Thus, the present invention is not limited to the embodiments shown, but is to be accorded the widest scope consistent with the principles and features disclosed herein.

The present invention relates a method for selective extraction of gold from mines as well as from chemical and electronic wastes by niacin.

In one embodiment, the present invention discloses a method for selective extraction of gold by precipitation process, wherein such precipitation occurs even at low concentrations using niacin, where niacin has the ability to recover gold down to 300 ppb.

In other embodiment, the present invention illustrates a rapid selective co-precipitation of [AuCl₄]⁻[2Niacin+H]⁺, abbreviated as I, in water from gold containing acidic mixtures by niacin. Electrostatic and supramolecular interactions such as hydrogen bonding and van der Waals (vdWs) interactions are responsible for such complexation, as revealed from single crystal studies. This phenomenon is highly selective for AuCl₄⁻ and excludes other commonly co-existing ions such as Cu²⁺, Zn²⁺ and Ni²⁺ present in such solutions, along with alkali (Na⁺/K⁺) and alkaline earth (Mg²⁺/Ca²⁺) metal ions. XPS and Raman studies also supported the formation of I.

In another embodiment, the present invention relates to a method for selective extraction of gold by precipitation process using niacin, wherein the [AuCl₄]⁻[2Niacin+H]⁺ in water from gold containing acidic mixtures is separated from impurities by filtration and then is reduced by a reductant to recover gold metal.

### Materials and Methods

### Chemicals

Niacin, CuCl₂·2H₂O, HAuCl₄·3H₂O and ZnCl₂, NaCl and MgCl₂ were purchased from Sigma-Aldrich and used without further purification. Ethanol, HCl and HNO₃ were purchased from Rankem. Milli-Q water was used throughout the experiment.

### Method

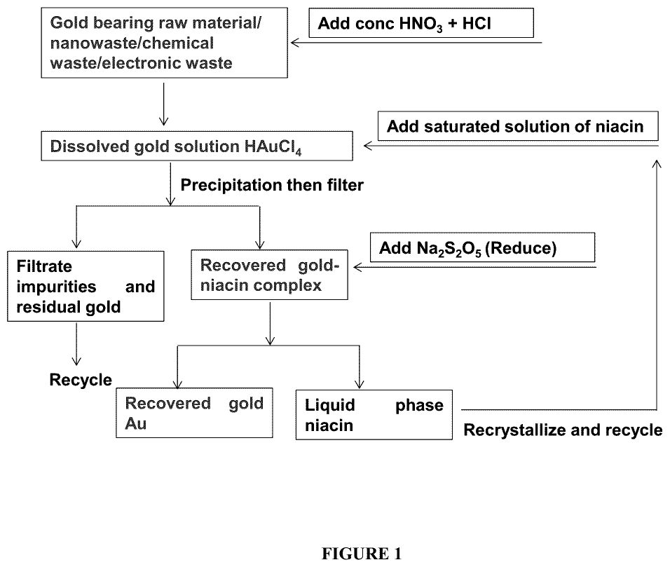

A process of gold recovery by niacin is presented as a flowchart in FIG. 1. Con. HCl and HNO₃ are added to gold bearing raw materials to dissolve the materials and then niacin is mixed to the dissolved gold solution. Adding niacin to the dissolved gold solution, HAuCl₄ leads to the precipitation of [AuCl₄]⁻[2Niacin+H]⁺, abbreviated as I. After precipitation, I is separated from impurities by filtration. Recovered I is reduced by using a reductant like sodium metabisulfite (Na₂S₂O₅) to recover gold metal. The remaining residual gold in the impurities and niacin (liquid phase) are recycled.

### Experimental Studies

### Instrumentation

### X-ray Crystallography

Single crystal X-ray data collection was performed using a Bruker D8 VENTURE APEX3 diffractometer using MoKα (λ=0.71073 Å) radiation. Indexing was performed using APEX3. The program, SAINT-v8.37A was used for integrating the data collection frames. Absorption correction was performed by a multi-scan method implemented in SADABS. The structure was solved using SHELXT-2018/2 and refined using SHELXL-2018/3 (full-matrix least-squares on F2) contained in WinGX v2018.3. Crystal data and refinement conditions are listed in the Table below. The crystal data has been deposited to the Cambridge Structural Database (CCDC no. 1989872).

TABLE 1
Crystal data and structure refinement for I

| | |
|---|---|
| Identification code | shelx |
| Empirical formula | C12 H11 Au Cl4 N2 O4 |
| Formula weight | 585.99 |
| Temperature | 293(2) K |
| Wave length | 0.71073 Å |
| Crystal system | Monoclinic |
| Space group | P 21/n |
| Unit cell dimensions | a = 7.2567(18) Å |
| | b = 10.516(4) Å |
| | c = 11.444(4) Å |
| Volume | 843.2(5) Å3 |
| Z | 2 |
| Density (calculated) | 2.308 Mg/m3 |
| Absorption coefficient | 9.376 mm−1 |
| F(000) | 552 |
| Crystal size | 0.200 × 0.150 × 0.100 mm3 |
| Theta range for data collection | 3.580 to 29.980°. |
| Index ranges | −9 <= h <= 10, −14 <= k <= |
| | 14, −15 <= l <= 16 |
| Reflections collected | 14924 |
| Independent reflections | 2426 [R(int) = 0.0557] |
| Completeness to theta = 25.242° | 98.90% |
| Absorption correction | Semi-empirical from equivalents |
| Max. and min. transmission | 0.7451 and 0.4461 |
| Refinement method | Full-matrix least-squares on F2 |
| Data/restraints/parameters | 2426/1/112 |
| Goodness-of-fit on F2 | 1.278 |
| Final R indices [I > 2sigma(I)] | R1 = 0.0271, wR2 = 0.0644 |
| R indices (all data) | R1 = 0.0354, wR2 = 0.0710 |
| Extinction coefficient | 0.0376(16) |
| Largest diff. peak and hole | 0.681 and −0.928 e · Å−3 |

### Inductively Coupled Plasma-Mass Spectrometry (ICP MS)

ICP MS was performed using a Perkin Elmer NexION 300X instrument equipped with Ar plasma. Before doing any sample, the instrument was calibrated with gold standard of four different concentrations (0, 10, 100 and 1000 ppb) to get a calibration curve with R²=0.9999. Blank experiment (0 ppb) was performed with milli-Q water (18.3 MΩ resistance) with 5% (v/v) hydrochloric acid. Standards were also prepared in 5% hydrochloric acid. The same amount (5%) of hydrochloric acid was added to the collected samples also before analyses. For other metals also, the instrument was calibrated with the standard by the same procedure, but 5% nitric acid was used.

### Scanning Electron Microscopy (SEM)

SEM (scanning electron microscopy) and energy dispersive analysis of X-rays (EDS) were performed using an FEI QUANTA-200 SEM.

### X-Ray Photoelectron Spectroscopy (XPS)

XPS measurements were performed with an Omicron ESCA Probe Spectrometer. It consists of EA 125 energy analyzer, XM 1000 MkII X-ray source and monochromator, DAR 400 X-ray source (Al/Mg), VUV source HIS 13, CN 10 and CN 10+ charge neutralizer system, ISE 10 sputter ion source and MKS residual gas analyzer for temperature programmed desorption (TPD). Polychromatic Al Kα X-rays (hv=1486.6 eV) were used for analysis.

### Precipitation of Compound I

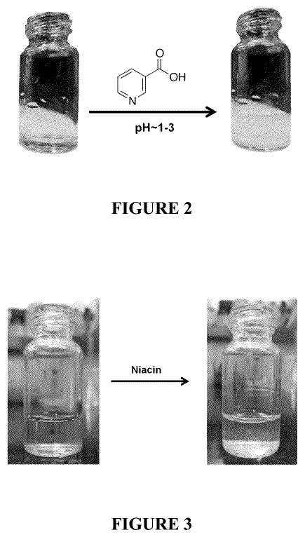

Niacin is nicotinic acid, and is a form of vitamin B₃, an essential human nutrient. It is produced industrially, and the sales was reported to be 31,000 tons in 2014 [Vitamins, 11. Niacin (Nicotinic Acid, Nicotinamide). In Ullmann's Encyclopedia of Industrial Chemistry, pp 1-9]. Upon addition of a saturated solution of niacin (2 mL) in water to an aqueous solution (1 mL, 27 mM) of HAuCl₄ at room temperature, a light yellow precipitate occurred within a few minutes (FIG. 2). The pH of the solution was maintained between 1-3, typical for an acid extraction processes. It was important to ensure that such precipitation occurs even at low concentrations for the process to be useful for gold recovery. It was confirmed that niacin had the ability to recover gold from solutions with concentration down to 300 ppb (FIG. 3).

### Crystal Data of Compound I

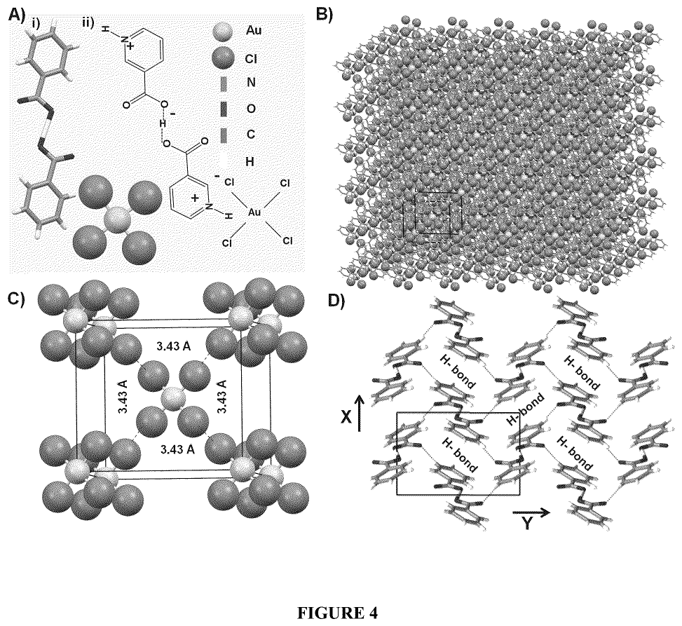

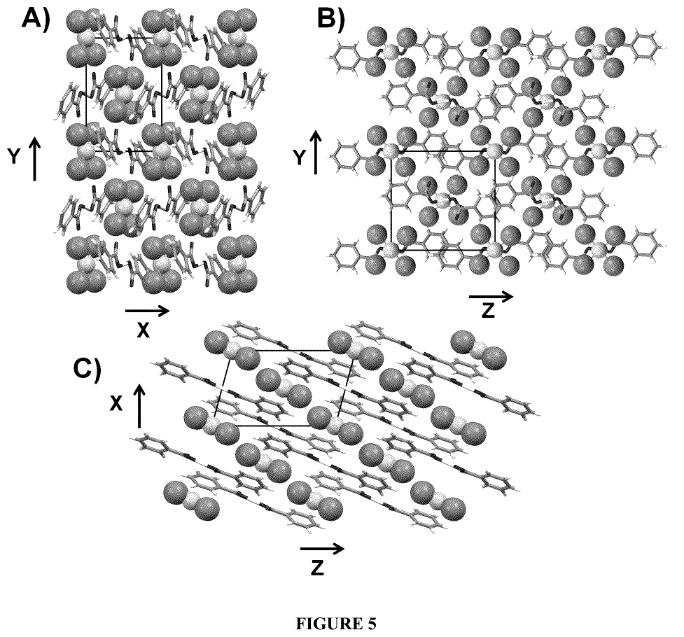

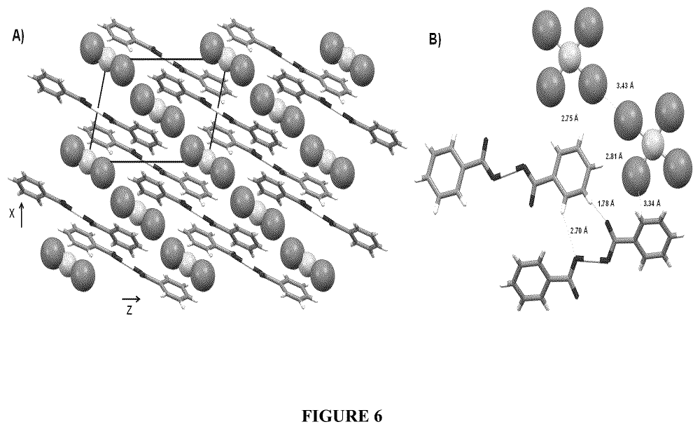

Compound I was crystallized using slow evaporation of water. Crystal structure of I is presented in FIG. 4A i), where two niacin molecules are interacting with one AuCl₄⁻. Simple representation of the crystal structure is shown in FIG. 4A ii). The crystal system is monoclinic with space group P 21/n (Table 1 and FIG. 3B). Expanded views of the unit cell in X, Y and Z directions are presented in FIG. 5. Layered structure of I along Y axis is evident from FIG. 6A. In the crystal, AuCl and a dimer of niacin molecules (with a proton link) are acting as anion and cation, respectively. The overall formula of the complex is [AuCl₄]⁻[2Niacin+H]⁺. The H atom is shared between two carboxylic groups of two niacin molecules (FIG. 4A). By looking at the chemical formula, it confirms that electrostatic interactions are present in the crystal structure. Strong H-bonding and vdW interactions are also responsible for such a complexation. VdW interactions between Cl atoms in the lattice are presented in FIG. 4C, which operate in the diagonal direction of the unit cell.

Similarly, H-bonding interactions between O atom of the carboxylic group and H connected to N are presented in FIG. 4D. Different types of H-bonding interactions were observed in the crystal (FIG. 4D). Such kind of self-organized and patterned structures are reminiscent of β-sheet and α-helix [Dunitz, J. D., Pauling's Left-Handed α-Helix. Angew. Chem. Int. Ed. 2001, 40 (22), 4167-4173] in proteins, and also in the recently reported Au₁₀₃ [Higaki, T.; Liu, C.; Zhou, M.; Luo, T.-Y.; Rosi, N. L.; Jin, R., Tailoring the Structure of 58-Electron Gold Nanoclusters: Au103S2(S-Nap)41 and its Implications. J. Am. Chem. Soc. 2017, 139 (29), 9994-10001] and Au₂₄₆ [Zeng, C.; Chen, Y.; Kirschbaum, K.; Lambright, K. J.; Jin, R., Emergence of Hierarchical Structural Complexities in Nanoparticles and Their Assembly. Science 2016, 354 (6319), 1580-1584] nanoclusters.

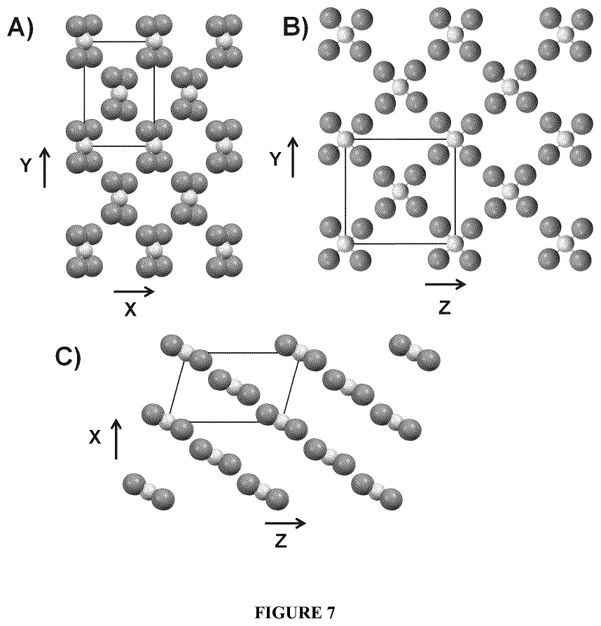

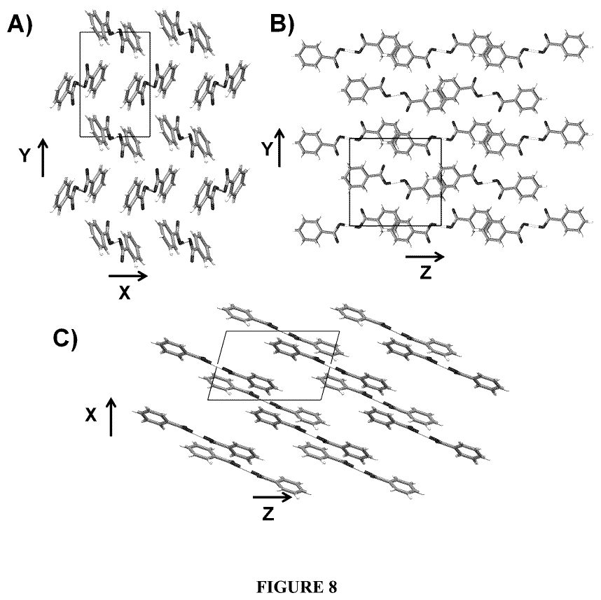

Expanded views of [AuCl₄]⁻ and [2Niacin+H]⁺ in X, Y and Z directions are presented in FIGS. 7 and 8, respectively. All kinds of non-covalent interactions present in the crystal are shown in FIG. 6B with specific distances. Non-covalent interactions between the hydrogen atoms of the aromatic ring and chlorines are also present in the crystal (FIG. 6B).

### Crystal Data of Cu(H₂O)₄(Niacin)₂

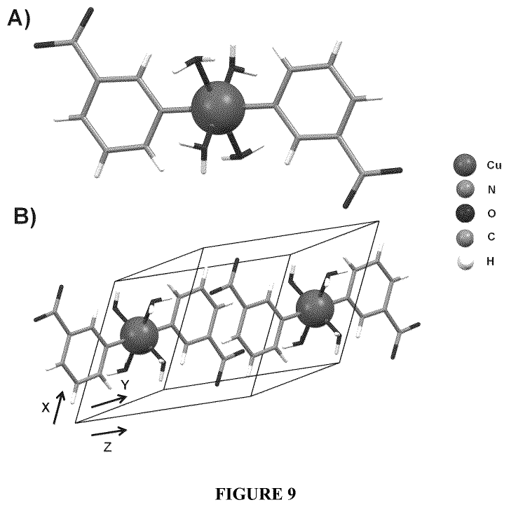

To understand the distinct difference in the gold complex, crystal structure of niacin with copper was also obtained (FIG. 9), which dissolves in water. 1 mL CuCl₂ (27 mM) and 3 mL saturated solution of niacin were mixed. The solution was kept for slow evaporation at room temperature. After 3 days, blue crystals were obtained. This structure is known already [Anacleto, B.; Gomes, P.; Correia-Branco, A.; Silva, C.; Martel, F.; Brandão, P., Design, Structural Characterization and Cytotoxic Properties of Copper(I) and Copper(II) complexes Formed by Vitamin B3 Type. Polyhedron 2017, 138, 277-286]. The overall formula of the complex is Cu(H₂O)₄(Niacin-H)₂. Here, copper formed a covalent bond with niacin through the N center of the heterocycle. Such type of covalent bond formation is absent in I because gold is a soft center while N and O are hard centers in niacin. The presence of various types of non-covalent interactions which are specific in the case of [AuCl₄]⁻ resulted in the precipitation of the complex.

### XPS Study of Compound I

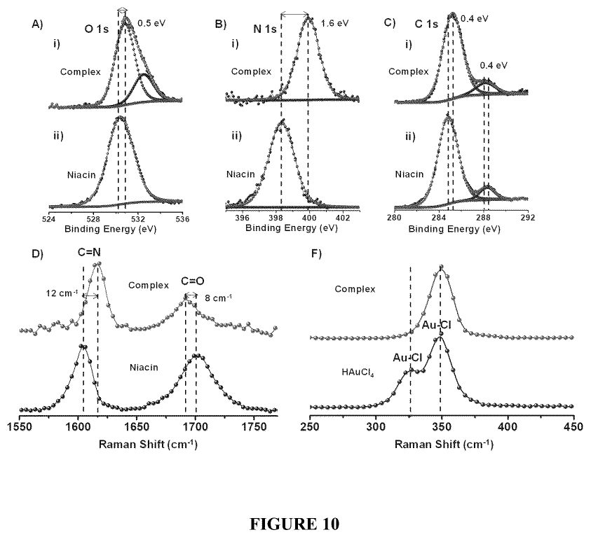

XPS study was also performed to reveal the interactions in the complex. Significant changes in binding energies were observed for oxygen and nitrogen in the complex compared to free niacin. In the case of O 1 s, a new peak appeared for I along with ˜0.5 eV chemical shifts compared to free niacin (FIG. 10A), which is due to the sharing of hydrogen between carboxylic groups of the two niacin molecules. Similarly, about 1.6 eV chemical shifts were observed for N1s in the complex compared to free niacin (FIG. 10B). This is due the presence of positive charge on N and H-bonding interactions (FIG. 4D). These data confirmed the presence of strong interactions in the complex. Binding energy of C 1s was also influenced by these interactions (FIG. 10C).

### Raman Spectroscopy Study of Compound I

To get further insights into bonding, Raman spectroscopy was performed. Peak shifts of 12 and 8 cm⁻¹ were observed for C═N and C═O vibrations, respectively in I compared to free niacin, which is also supported XPS and single crystal XRD data (FIG. 10D). There were two types of Au—Cl stretching for HAuCl₄. This is due to Au—Cl (348 cm⁻¹) in AuCl₄⁻ and Au—Cl (326 cm⁻¹) in AuCl₃(OH)⁻(FIG. 10F, HAuCl₄). Note that the spectrum of HAuCl₄ was measured in ambient air, which resulted in water of hydration as the salt is hygroscopic. As the crystal structure of I does not have any OH attached to gold, only one Au—Cl stretching band appeared (FIG. 10F). Both XPS and Raman spectroscopy are in good agreement with the single crystal XRD data of I.

### Selectivity Study

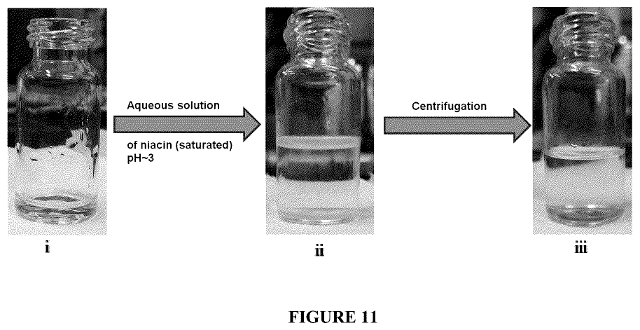

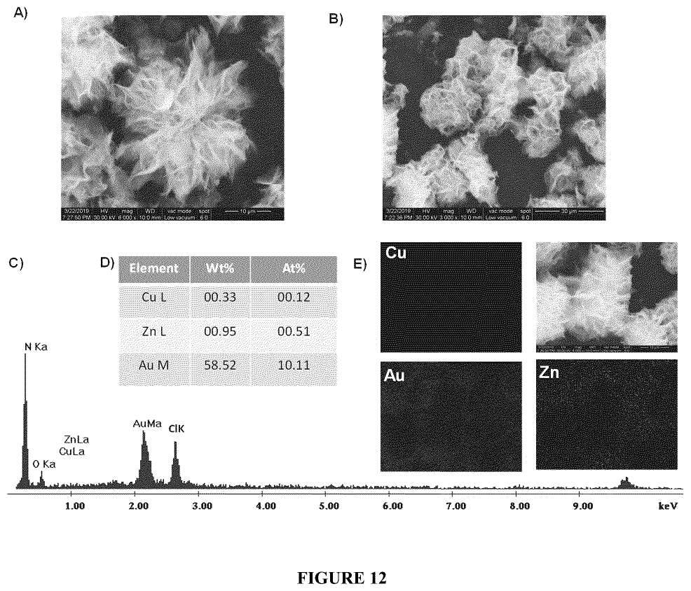

In order to test the selectivity, an equimolar mixture of HAuCl₄, CuCl₂ and ZnCl₂ (27 mM each) was prepared by mixing corresponding salts. After adding a saturated solution of niacin, precipitation of gold complex occurred immediately, but copper and zinc were still in solution (FIG. 11). Precipitation was examined using SEM/EDS mapping to confirm the efficiency of this method for selectivity towards gold. SEM images revealed the formation of mesoflower kind of structures. SEM images of the precipitate are provided in FIG. 12A-B. SEM/EDS confirmed the presence of N, O, Cl, Au, Cu and Zn (FIG. 12D). Au (10.11%), Zn (0.51%) and Cu (0.12%) were quantified by EDS mapping from the coprecipitate. About 94% of gold was extracted using this method after one time treatment of niacin. Elemental analysis of the precipitate is provided in FIG. 12D. Elemental maps of copper, gold, and zinc are shown in FIG. 12E.

### EXAMPLES

### Example 1: Recovery from Waste

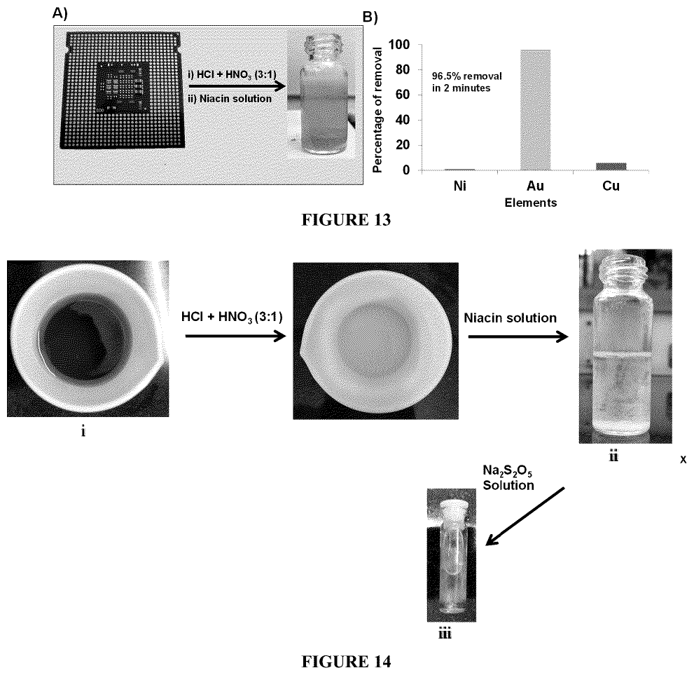

Gold was recovered from electronic waste and laboratory nano-waste. A used central processing unit (CPU) of a computer was treated with 5 mL aqua regia (HCl and HNO₃ in 3:1 volume ratio) to dissolve the metals (FIG. 13A). The solution was heated for 2 h to remove excess acids, yielding 2 mL solution, which was blue in color. It contained 770 ppm of Ni²⁺, 22,320 ppm of Cu²⁺, and 25 ppm Au³⁺ by ICP MS analysis. Saturated solution of niacin in tap water (4 mL) containing common ions was added to it. After the treatment of niacin, about 96.5% of gold was recovered within 2 minutes. Removal of different metals is presented in FIG. 13B. Hence, it is established that niacin is highly efficient for the recovery of gold from electronic wastes.

A simulated nanowaste consisting of citrate reduced AuNPs was synthesized. The colloidal AuNPs were precipitated using NaCl-induced aggregation and the precipitate was dissolved using aqua regia. The niacin-based separation was done as before. The clear yellow solution became turbid just after addition of niacin. The reaction mixture was filtered through a Whatman filter paper. The precipitate was added to about 50 mM solution of Na₂S₂O₅ to recover gold. All stages involved in the recovery process were performed at room temperature (FIG. 14).

### Example 2: Recovery In Certain Extreme Conditions

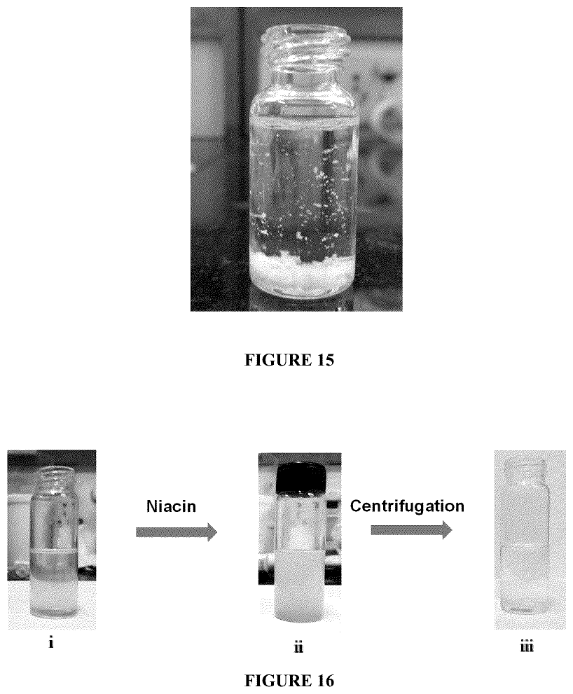

Recovery was attempted in certain extreme conditions also. 1 ppm of gold solution was taken in presence of 160,000 ppm NaCl and 50,000 ppm MgCl₂. Coprecipitation was observed after 2 days of exposure to saturated niacin solution (FIG. 15). This indicates that the present method is effective to collect gold from extreme saline solutions.

### Effect of Solvent

Solvent also plays a key role in the process. An equimolar mixture of HAuCl₄ and CuCl₂ (27 mM) in ethanol was prepared. In this case, precipitation of copper-niacin complex was observed, while gold was retained in the solution as shown in FIG. 16.

Ethionamide and nicotinamide are common derivatives of niacin, and they also form complexes with precious metals and work for such recovery and extraction. Similarly, other square planar complexes of precious metals such as PdCl₄²⁻, PtCl₄²⁻, etc., also form precipitates with niacin and its derivatives.

Thus the present invention discloses a fast precipitation and extraction method of gold in water by a simple biomolecule, niacin. Crystal structure of I revealed the presence of strong electrostatic, H-bonding and vdW interactions in the crystal. Such types of interaction are the main reason for selective precipitation of I. Further, Raman spectroscopy and XPS were employed to support the single crystal XRD data. This method is highly selective for gold. Trace amounts of gold is recovered from complex mixtures. The method is employed for selective extraction of gold from electronic and chemical wastes.

It may be appreciated by those skilled in the art that the foregoing drawings, examples and experimental evidences are merely illustrative and are not to be taken as limitations upon the scope of the invention. Various changes and modifications to the disclosed embodiments will be apparent to those skilled in the art. Such changes and modifications may be made without departing from the scope of the invention.

We claim:

1. A method for selectively precipitating and extracting gold in aqueous solution, the said method comprises
a. Adding conc. HCl and HNO₃ in 3:1 ratio to the gold bearing raw materials to obtain a dissolved gold solution HAuCl₄;
b. Adding saturated niacin in water to the dissolved gold solution HAuCl₄ to precipitate [AuCl₄]⁻[2Niacin+H]⁺ complex;
c. Filtering the obtained precipitate of step (b) to remove impurities;
d. Adding a reductant to the recovered [AuCl₄]⁻[2Niacin+H]⁺ complex of step (c) to reduce the complex and to extract gold metal;
wherein, niacin selectively precipitates and recovers gold from gold containing acidic mixtures at concentrations as low as 300 ppb.

2. The method as claimed in claim 1, wherein the raw materials comprise waste samples including chemical wastes, electronic wastes and laboratory nano-wastes.

3. The method as claimed in claim 1, wherein the reductant is sodium metabisulfite.

4. The method as claimed in claim 1, wherein the precipitation occurs at room temperature.

5. The method as claimed in claim 1, wherein niacin selectively precipitates [AuCl₄]⁻[2Niacin+H]⁺ excluding other commonly coexisting ions including Cu²⁺, Zn²⁺, Ni²⁺Na⁺, K⁺, Mg²⁺ and Ca²⁺ present in solution.

6. The method as claimed in claim 1, wherein NaCl is added to slow down the precipitation.

7. The method as claimed in claim 1, wherein niacin precipitates and recovers about 96.5% of gold in 2 minutes from an electronic waste composed of Au, Cu and Ni.

8. The method as claimed in claim 1, wherein niacin precipitates copper from a mixture of gold and copper solution in solvent ethanol.

9. The method as claimed in claim 1, wherein the said complexation occurs with niacin and derivatives of niacin including ethionamide and nicotinamide.

10. The method as claimed in claim 1, wherein niacin and its derivates precipitates precious metals having square planar complexes including PdCl₄²⁻, PtCl₄²⁻.
